(19) United States
(12) Patent Application Publication
(10) Pub. No.: US 2014/0005309 A1
(43) Pub. Date: Jan. 2, 2014

(54) VULCANIZATION COMPOSITION IN THE FORM OF GRANULES, PROCESS FOR PREPARING SAME AND USE THEREOF

(71) Applicants: Serge Krafft, Irigny (FR); Delphine Simard, Lyon (FR)

(72) Inventors: Serge Krafft, Irigny (FR); Delphine Simard, Lyon (FR)

(73) Assignee: EIFFAGE TRAVAUX PUBLICS, Neuilly Sur Marne (FR)

(21) Appl. No.: 14/006,305

(22) PCT Filed: Mar. 20, 2012
(86) PCT No.: PCT/FR12/50584

§ 371 Date: Sep. 19, 2013

(30) Foreign Application Priority Data
Mar. 22, 2011 (FR) 11 52359

(51) Int. Cl. C08K 3/06; C08L 95/00

(52) U.S. Cl. CPC C08K 3/06; C08L 95/00
USPC 524/68; 252/182.17

(57) ABSTRACT

The present invention relates to a granule comprising:
less than 30%, preferably between 0.5 and 20%, more preferably between 2 and 5% by weight of bitumen; and
more than 70%, preferably between 80 and 99.5%, more preferably between 95 and 98% by weight of a vulcanization composition comprising a vulcanization agent; to the process for manufacturing same by extrusion and the use of same in modified bitumens.

The present invention relates to solid granules comprising a bituminous matrix and containing a high level of vulcanizing composition. The invention also relates to a method for producing these granules by coextruding bitumen and a vulcanizing composition, and to the use of these granules in a method for producing modified bitumens.

Bitumens are substances composed of a mixture of hydrocarbons which is highly viscous or even solid at ambient temperature. They are used in the production of materials for road or industrial applications. In order to enhance their mechanical properties, polymers (especially elastomers) are added to these bitumens. These additized bitumens, also called modified bitumens, are further enhanced, stabilized, and thus rendered storable by vulcanization (or crosslinking) of the polymers.

The polymers are vulcanized by the addition of a vulcanizing agent. This vulcanizing agent, in general based on sulfur or on sulfur compounds, is commonly present in the form of pulverulent compositions. The pulverulence of these compositions gives rise to certain health, handling, and storage problems. The reason is that the pulverulence of these compositions based on sulfur or on sulfur compounds gives rise to odors and dusts that are undesirable and irritant or even toxic. Furthermore, these pulverulent compositions are sensitive to moisture and have a tendency to agglomerate during storage, and this may give rise to handling difficulties and, in particular, to disruptions to the machine feed systems.

In the face of these difficulties, some vulcanizing compositions in liquid form have been proposed. These compositions, however, do not result in modified bitumens having the required specifications, owing to the nature of the vulcanizing agents employed.

WO2010/100603 proposes a vulcanizing composition in granule form for producing crosslinked elastomer/bitumen mixtures while limiting the emissions of hydrogen sulfide. These granules are obtained by coextruding a polymeric matrix with a vulcanizing composition. These granules, however, have the disadvantage that they contain a not inconsiderable amount of polymer, at the expense of the active vulcanizing compounds.

Consequently there continues to be a need among those in industry for a nonpulverulent vulcanizing composition providing a combination of secure health during handling, ease of handling and storage, a high vulcanizing composition content, and easy mixing with the bitumen.

After lengthy research, the Applicant has developed a vulcanizing composition in granule form with a bituminous matrix that comprises a large amount of vulcanizing composition. These granules may be obtained by low-temperature coextrusion of a bitumen and a vulcanizing composition.

The present invention therefore relates to granules comprising:
less than 30%, preferably between 0.5% and 20%, more preferably between 2% and 5% by weight of bitumen; and
more than 70%, preferably between 80% and 99.5%, more preferably between 95% and 98% by weight of a vulcanizing composition comprising a vulcanizing agent.

The vulcanizing composition employed in the granules is advantageously in pulverulent form.

According to one particular embodiment, the vulcanizing agent present in the vulcanizing composition may be sulfur or an organic sulfur compound. More particularly the vulcanizing agent may be selected from sublimed sulfur or a sulfur donor in combination with a sulfenamide, said sulfur donor being selected from thiurams and dithiomorpholines.

In one particular embodiment the vulcanizing composition further comprises a vulcanization activator, a vulcanization coactivator, a vulcanization accelerator, an antioxidant, or mixtures thereof. The vulcanizing composition advantageously comprises by weight:
1 to 5 parts of vulcanizing agent;
3 to 5 parts of vulcanization activator;
1 to 3 parts of vulcanization coactivator;
1 to 6 parts of vulcanization accelerator;
1 to 4 parts of antioxidant.

The vulcanization accelerator is composed of a mixture of thiazole and thiuram. This mixture is preferably a 50/50 mixture. In this mixture the thiazole is, for example, mercaptobenzothiazole and the thiuram is, for example, tetramethylthiuram disulfide.

The vulcanization activator is a metal oxide, such as zinc oxide.

The coactivator is a fatty acid, such as stearic acid.

The antioxidant is an acetodiphenylamine condensate or a quinone derivative, such as tetramethylbenzoquinone.

The vulcanizing composition described in patent application EP 0 299 820 is particularly suitable for the present invention. An example of a pulverizing composition is the product sold by the Applicant Company under the brand name Retiflex®.

The bitumen must be selected such that it is soft enough to allow the mixture to be produced by low-temperature coextrusion but must remain sufficiently hard at ambient temperature to produce nonsticking solid granules and to prevent agglomeration of the granules during storage. The bitumen is selected more particularly from bitumens having a penetrability at 25° C., measured in accordance with standard NF EN 1423, of between 50 and 220, preferably between 70 and 100 (penetrability values are expressed in tenths of millimeters), and a ring & ball temperature, measured in accordance with standard NF EN 1427, of between 35 and 60° C., preferably between 43 and 51° C. The bitumen will advantageously be selected from bitumens commonly referred to as of 50/70, 70/100, and 160/220 grade in accordance with standard NF EN 1423.

The granules of the invention have the advantage of being solid, nonfriable, and nonagglomerating. They therefore afford ease of handling and secure health by comparison with a pulverulent vulcanizing composition. Moreover, the granules of the invention have a bituminous matrix, which makes them easier to incorporate into a bitumen, relative to a pulverulent composition or to granules having a polymeric matrix. Lastly, the granules of the invention contain a large amount of vulcanizing composition.

In one particular embodiment the granules of the invention contain no flyash, silica, silica-based materials, or mixtures thereof. The granules of the invention preferably contain no mineral fillers. According to another particular embodiment, the granules of the invention contain no polymeric compounds, waxy material, or mixtures thereof.

The term “polymeric compounds” in the sense of the present invention refers to thermoplastic polymers such as polyethylenes, ethylene/propylene copolymers, ethylene/acrylic ester copolymers, ethylene/glycol monostearate copolymers, ethylene/vinyl acetate copolymers, and mixtures thereof.

The term “waxy material” in the sense of the present invention refers in particular to paraffinic waxes, waxes of vegetable or animal origin, petroleum-derived waxes, or waxes based on fatty acid derivatives.

Entirely remarkably, and contrary to every expectation, the inventors have found that even in the absence of any polymeric compound or any waxy material, the granules according to the invention exhibited excellent mechanical strength and could be stored without problems either of agglomeration of the granules to one another or of disintegration of the granules.

The granules according to the invention are therefore such that they exhibit a stability on storage of at least 3 months at ambient temperature, preferably at least 6 months. The stability on storage is evaluated by the following test: 50 g of granules are placed in a cylindrical can with a diameter of 10 cm, with a load of 1.6 kg, and are stored for 15 days in an oven at 50° C., so as to simulate storage in a store shed and the heaping of bags. The granules are considered to be stable if they have not undergone disintegration during this test, and are still able to flow freely, meaning that they have not solidified or formed agglomerates with one another.

The granules as defined above can be obtained by coextrusion. The present invention accordingly further provides a method for producing granules as defined above, which comprises mixing by coextrusion less than 30%, preferably from 0.5% to 20%, more preferably between 2% and 5% by weight of bitumen with more than 70%, preferably between 80% and 99.5%, more preferably between 95% and 98% by weight of a vulcanizing composition comprising a vulcanizing agent.

The vulcanizing composition and the bitumen are advantageously selected as defined earlier on above. The vulcanizing composition is more particularly in pulverulent powder form.

The coextrusion process may be carried out in a single-screw extruder, a corotating twin-screw extruder, or a contrarotating twin-screw extruder, preferably on a corotating twin-screw extruder. The screw profile must be selected to allow homogeneous mixing while preventing excessive heating of the mixture. The screw profile, for example, may comprise four zones: a zone A and a zone B comprising conveying elements, a zone C comprising at least one mixing element, and a zone D comprising conveying elements.

The temperature profile along the screw profile is regulated by temperature control systems. It must be selected such that it allows homogeneous mixing of the bitumen and the vulcanizing composition. More particularly the temperature must be high enough to maintain the bitumen in liquid form while remaining low enough to prevent degradation of the active compounds in the vulcanizing composition. The temperature profile under steady-state conditions advantageously does not exceed 100° C.

In one particular embodiment the vulcanizing composition is introduced into zone A, where it can be brought to temperature, and transported on to zone B. The bitumen, heated beforehand, is introduced in zone B, and undergoes first mixing with the vulcanizing composition. The mixture is mixed and homogenized in zone C, and then transported the length of zone D to an outlet head. The temperature profile is, for example, from 70 to 80° C., preferably 80° C. in zone A, from 80 to 100° C., preferably 90° C. in zone B, from 70 to 80° C., preferably 80° C. in zone C, and from 80 to 100° C., preferably 90° C. in zone D. The temperature of the outlet head may be adapted so as to facilitate the passing of the mixture into a die and the chopping of the resulting extrudate. The temperature of the outlet head may be between 80 and 140° C., preferably 100° C. The mixture then passes into a die so as to give an extrudate. The granules according to the invention may be obtained either by chopping or by crushing of this extrudate. Chopping may be carried out under water or in air by means of a blade, a rotary chopping head equipped with knives, or any other device allowing the mixture to be granulated or chopped. Chopping may be carried out, for example, in hot water at between 30 and 90° C., preferably between 50 and 85° C., depending on the grade of bitumen used in the vulcanizing composition. Chopping may alternatively be carried out in air at a temperature of between 20° C. and 100° C., these chopping conditions being dependent on the grade of bitumen used. The granules may be subsequently cooled, by stream of air or by water, for example, before being optionally dried.

An anticaking agent, such as talc, zinc stearate, or calcium stearate, may optionally be applied to the surface of the granules, by spraying, for example.

The present invention also relates to the use of the granules of the invention in a method for producing a modified bitumen. The granules of the invention may be used more particularly in a method for producing modified bitumen that comprises mixing a bitumen, a polymer, and granules as defined above. In such a method, the granules according to the invention take the place of the conventional liquid or pulverulent vulcanizing composition.

In one particular embodiment the method for producing modified bitumen according to the invention comprises:
heating a bitumen at between 160 and 200° C.;
adding a polymer with stirring;
adding the granules according to the invention, optionally simultaneously with the polymer;
aging the resulting mixture with stirring at between 160 and 200° C. for 1 to 300 minutes;
recovering a modified bitumen.

Any type of road bitumen conventionally used may be employed for producing modified bitumens according to the invention. By way of example, the bitumen will be selected from bitumens commonly referred to as of 20/30, 35/50, 50/70, 70/100, and 160/220 grade in accordance with standard NF EN 1423. Polymers suitable for this mixture are the elastomers that can conventionally be used in the field of modified bitumens, such as, for example, polybutadienes, polyisoprenes, butyl rubbers, ethylene/propylene/diene terpolymers, styrene/isoprene copolymers, styrene/butadiene copolymers (such as styrene/butadiene block polymer (SB) or styrene/butadiene/styrene block copolymer (SBS)), alone or in a mixture. The mixture may comprise between 75% and 98%, preferably between 90% and 98% of bitumen, between 1% and 15%, preferably between 1% and 8% of polymer, and between 0.05% and 5%, preferably between 0.1% and 2%, of granules according to the invention, the percentages being expressed by weight in relation to the total composition.

The examples which follow illustrate the method for producing granules according to the invention and also their use, and their advantage. These examples are given only with the aim of illustration, and may not be considered to impose any limitation.

### EXAMPLES

### Example 1

### Production of Granules According to the Invention

Different types of granules according to the invention were prepared, using variable amounts of bitumen and of pulverulent vulcanizing composition.

The bitumen used is a 70/100 grade bitumen having a penetrability at 25° C. of 89 and a ring & ball temperature of 44.6° C.

The pulverulent vulcanizing composition is composed of:
21.44% by weight of sulfur,
21.43% by weight of stearic acid,
35.71% by weight of zinc oxide,
7.14% by weight of mercaptobenzothiazole,
7.14% by weight of tetramethylthiuram disulfide, and
7.14% by weight of tetramethylbenzoquinone.

The granules were obtained by coextrusion on a counter-rotating twin-screw extruder composed of four zones:
zone A: conveying zone, held at 80° C.;
zone B: conveying zone, held at 90° C.;
zone C: mixing zone, held at 80° C.; and
zone D: conveying zone, held at 90° C.;
   and equipped with an outlet head heated at 100° C., a die, and a rotary chopping head equipped with knives, allowing the granules to be chopped.

The vulcanizing composition was introduced at the start of zone A, and the bitumen was introduced at the start of zone B.

Table 1 summarizes the composition of the granules produced.

TABLE 1

| | | % by weight of |
|---|---|---|
| | % by weight of | vulcanizing |
| Test | bitumen | composition |
| 1 | 28.3 | 71.7 |
| 2 | 17.2 | 82.8 |
| 3 | 8.2 | 91.8 |
| 4 | 5.5 | 94.5 |
| 5 | 4.2 | 95.8 |

Each of these tests gave solid granules.

### Example 2

### Storage Stability of the Granules According to the Invention

To evaluate the stability of the granules on storage, 50 g samples of the granules from each of tests 1 to 5 were stored in a cylindrical container with a diameter of 10 cm, with a load of 1.6 kg, for 15 days in an oven at 50° C., so as to simulate store shed storage and the heaping of bags.

No formation of powder or clogging between the granules was observed, hence showing that the granules of the invention are nonfriable, nonagglomerating, and stable.

### Example 3

### Evaluation of a Modified 70/100 Bitumen According to the Invention

A modified bitumen Al was produced from:
95.4% by weight of a 70/100 grade bitumen having a penetrability at 25° C. of 79 and a ring & ball temperature of 46.9° C., originating from the Lavéra refinery and sold by BP Company;
4% by weight of 1,3-butadiene-styrene block polymer in granule form, sold by the ICO POLYMERS company under the brand name SBS ICO 101B; and
0.6% by weight of the pulverulent vulcanizing composition of example 1.

The bitumen was heated in an oven in accordance with standard NF EN 12594. The polymer was then added and the resulting composition was heated at 180° C. and mixed using an Ultra Turrax (rotor stator) for 3 minutes. Lastly the pulverulent vulcanizing composition was added and the composition was heated at 180° C. and mixed using an Ultra Turrax (rotor stator) for 30 seconds. The mixture obtained was mixed, lastly, for 1 hour 30 minutes at 180° C. with the aid of a conventional mixer (Rayneri type). The modified bitumen Al obtained and its characteristics were evaluated. The results are set out in table 2 below.

In the same way, a modified bitumen B1 was produced, by replacing the pulverulent vulcanizing composition of example 1 with the granules from test 5 in example 1. The respective proportions of bitumen, polymer, and granules according to the invention were adapted such that the amount of vulcanizing composition added for the production of the modified bitumen B1 corresponds to that added for the production of the modified bitumen A1.

The modified bitumen B1 obtained and its characteristics were likewise evaluated. The results are set out in table 2 below.

TABLE 2

Modified bitumens

| | | A1 | |
|---|---|---|---|
| | Specification | (comparative) | B1 |
| Ring & ball | ≧65 | 67.4 | 67.6 |
| temperature (° C.) | | | |
| Penetrability at | 40-70 | 59 | 60 |
| 25° C. (10⁻¹ mm) | | | |
| Viscosity at 160° C. | | 3.38 | 3.39 |
| (Pa · s) | | | |
| Elastic recovery (%) | ≧85 | 86 | 85 |
| Fraass breaking | ≈−15 | −17 | −17 |
| point (° C.) | | | |
| Settling (%) | ≧90 | 99 | 98 |

### Example 4

### Evaluation of a Modified 50/70 Bitumen According to the Invention

A modified bitumen A2 was produced in the same way as in example 3, from:
97.125% by weight of a 50/70 grade bitumen having a penetrability at 25° C. of 63 and a ring & ball temperature of 49.2° C., sold by IES Company;
2.5% by weight of 1,3-butadiene-styrene block polymer in granule form, sold by the ICO POLYMERS company under the brand name SBS ICO 101B; and
0.375% by weight of the pulverulent vulcanizing composition of example 1.

In the same way, a modified bitumen B2 was produced, by replacing the pulverulent vulcanizing composition of example 1 with the granules from test 5 in example 1. The respective proportions of bitumen, polymer, and granules according to the invention were adapted such that the amount of vulcanizing composition added for the production of the modified bitumen B2 corresponds to that added for the production of the modified bitumen A2.

The characteristics of the modified bitumens A2 (comparative) and B2 (inventive) obtained are set out in table 3 below.

TABLE 3

Modified bitumens

| | | A2 | |
|---|---|---|---|
| | Specification | (comparative) | B2 |
| Ring & ball | ≧50 | 58.2 | 59 |
| temperature (° C.) | | | |
| Penetrability at | 40-60 | 46 | 50 |
| 25° C. (10⁻¹ mm) | | | |
| Viscosity at 160° C. | ≈3.5 | 3.36 | 3.4 |
| (Pa · s) | | | |
| Elastic recovery (%) | ≧60 | 68 | 68 |
| Fraass breaking | ≈−10 | −13 | −12 |
| point (° C.) | | | |
| Settling (%) | ≧90 | 100 | 98 |

### Example 5

### Evaluation of a Modified 35/50 Bitumen According to the Invention

A modified bitumen A3 was produced in the same way as in example 3, from:
97.125% by weight of a 35/50 grade bitumen having a penetrability at 25° C. of 38 and a ring & ball temperature of 53.2° C., originating from the Lavéra refinery and sold by BP Company;
2.5% by weight of 1,3-butadiene-styrene block polymer in granule form, sold by the ICO POLYMERS company under the brand name SBS ICO 101B; and
0.375% by weight of the pulverulent vulcanizing composition of example 1.

In the same way, a modified bitumen B3 was produced, by replacing the pulverulent vulcanizing composition of example 1 with the granules from test 5 in example 1. The respective proportions of bitumen, polymer, and granules according to the invention were adapted such that the amount of vulcanizing composition added for the production of the modified bitumen B3 corresponds to that added for the production of the modified bitumen A3.

The characteristics of the modified bitumens A3 (comparative) and B3 (inventive) obtained are set out in table 4 below.

TABLE 4

Modified bitumens

| | | A3 | |
|---|---|---|---|
| | Specification | (comparative) | B3 |
| Ring & ball | ≧54 | 61.2 | 62 |
| temperature (° C.) | | | |
| Penetrability at | 30-45 | 37 | 39 |
| 25° C. (10⁻¹ mm) | | | |
| Viscosity at 160° C. | | 2.44 | 2.53 |
| (Pa · s) | | | |
| Elastic recovery (%) | ≧60 | 72 | 74 |
| Fraass breaking | ≈−10 | −11 | −13 |
| point (° C.) | | | |
| Settling (%) | ≧90 | 98 | 98 |

For each of the modified bitumens above, observation under the microscope showed a slightly granular coherent yellow base. The modified bitumens according to the prior art and according to the invention therefore exhibit an identical microstructure.

It is noted that all of the results for each of the modified bitumens according to the invention (B1, B2, and B3) validate the required specifications, and exhibit characteristics equivalent to those of the corresponding modified bitumens according to the prior art (A1, A2, and A3).

These evaluations therefore validate the advantage of the granules according to the invention.

1. Granules comprising:
between 0.5% and 30% by weight of bitumen; and
between 70% and 99.5% by weight of a vulcanizing composition comprising a vulcanizing agent;
said granules containing no flyash, silicas, silica-based materials, or mixtures thereof.

2. The granules as claimed in claim 1, characterized in that the vulcanizing agent is sublimed sulfur or a sulfur donor in combination with a sulfenamide, said sulfur donor being selected from thiurams and dithiomorpholines.

3. The granules as claimed in claim 1, characterized in that the vulcanizing composition further comprises a vulcanization activator, a vulcanization accelerator, an antioxidant, an emulsifier, or mixtures thereof.

4. The granules as claimed in claim 1, characterized in that the vulcanizing composition is pulverulent.

5. The granules as claimed in claim 1, characterized in that they are free of polymeric compounds.

6. The granules as claimed in claim 1, characterized in that the bitumen is selected from
bitumens having a penetrability at 25° C., measured in accordance with standard NF EN 1423, of between 50 and 220 and a ring & ball temperature, measured in accordance with standard NF EN 1427, of between 35 and 60° C.

7. A method for producing granules as defined in claim 1, which comprises mixing by coextrusion of between 0.5% and 30% by weight of bitumen with between 70% and 99.5% by weight of a vulcanizing composition comprising a vulcanizing agent.

8. The method as claimed in claim 7, characterized in that the coextrusion temperature profile does not exceed 100° C.

9. (canceled)

10. The granules as claimed in claim 1 comprising:
between 0.5% and 20% by weight of bitumen; and
between 80% and 99.5% by weight of a vulcanizing composition comprising a vulcanizing agent.

11. The granules as claimed in claim 1 comprising:
between 2% and 5% by weight of bitumen; and
between 95% and 98% by weight of a vulcanizing composition comprising a vulcanizing agent.

12. The method as claimed in claim 7, which comprises mixing by coextrusion of between 0.5% and 20% by weight of bitumen with between 80% and 99.5% by weight of a vulcanizing composition comprising a vulcanizing agent.

13. The method as claimed in claim 7, which comprises mixing by coextrusion of between 2% and 5% by weight of bitumen with between 95% and 98% by weight of a vulcanizing composition comprising a vulcanizing agent.

14. A method for producing a modified bitumen comprising mixing a bitumen, a polymer, and granules as defined in claim 1.

15. A method for producing a modified bitumen comprising mixing a bitumen, a polymer, and granules as produced by the method of claim 7.
